(19) United States
(12) Patent Application Publication
(10) Pub. No.: US 2015/0262021 A1
(43) Pub. Date: Sep. 17, 2015

(54) SYSTEMS AND METHODS FOR AUTOMATING CUSTOMER PREMISES EQUIPMENT REGISTRATION

(71) Applicant: Peter Som De Cerff, Broken Arrow, OK (US)

(72) Inventor: Peter Som De Cerff, Broken Arrow, OK (US)

(21) Appl. No.: 13/016,526

(22) Filed: Jan. 28, 2011

(51) Int. Cl. H04W 4/02; G06K 9/00; G06K 9/18

(52) U.S. Cl. CPC G06K 9/18; H04W 4/02; G06K 9/00483

(57) ABSTRACT

A system for automating customer premises equipment (CPE) registration has CPE located at a customer premises. The CPE has a product identifier, such as a serial number or barcode, located on a housing of the CPE for identifying the CPE, and a data storage element is located in a network for storing customer data, including customer premises location information. A technician uses a mobile communication device to automatically detect the product identifier, and the mobile communication device has a location sensor configured to determine the location of the device. The mobile communication device is configured to transmit a message indicative of the product identifier and the location of the device to the data storage element via a cellular network, and the data storage element is configured to automatically associate the product identifier with a customer based on the customer data and the location of the device.

### RELATED ART

Network technicians often travel to a customer promises to install customer premises equipment (CPE), such as, for example, modems and set-top boxes, in order to enable data communication between the customer premises and a network based upon a customer's service contract. The CPE is often connected to the network via one or more subscriber lines. The CPE typically has a product identifier, such as a serial number or barcode, located on a housing of the CPE in order to identify the CPE and to assist the network service provider in determining whether the proper CPE is installed at the customer premises based on the customer's service contract or work order. Upon installation of the CPE, the technician registers the installed CPE such that the product identifier of the CPE is associated with the appropriate customer in a customer database in order to allow the network service provider to properly manage, provision, and deliver services to the CPE.

Currently, a variety of CPE registration techniques exist. One such technique involves manual entry of registration information, such as, for example, the CPE serial number and the work order ID, by the technician. However, manual entry is prone to mistakes and burdensome to the technician. Another such technique involves using a scanner to scan and identify the product identifier, but use of a scanner also typically requires some type of manual association between the scanned information and the customer. Thus, the burdens and drawbacks of manual entry of CPE registration information are not completely eliminated via the use of a scanner. Further, conventional scanners can be expensive and/or burdensome to carry for a technician in the field. Accordingly, systems and methods for automating and facilitating CPE registration are generally desired.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram depicting an exemplary embodiment of a communication system.

FIG. 2 depicts an exemplary embodiment of CPE, such as is depicted by FIG. 1.

FIG. 3 depicts an exemplary embodiment of a mobile communication device, such as is depicted by FIG. 1.

FIG. 4 is a block diagram depicting an exemplary embodiment of a data storage element, such as is depicted by FIG. 1.

FIG. 5 is a table depicting an exemplary embodiment of customer data, such as is depicted by FIG. 4.

FIG. 6 is a table depicting an exemplary embodiment of work order data, such as is depicted by FIG. 4

FIG. 7 is a flowchart illustrating an exemplary method of automating CPE registration.

### DETAILED DESCRIPTION

Embodiments of the present disclosure generally pertain to systems and methods for automating customer premises equipment (CPE) registration. A system in accordance with an exemplary embodiment of the present disclosure comprises CPE located at a customer premises. The CPE has a product identifier, such as a serial number or barcode, located on a housing of the CPE for identifying the CPE. The system further comprises a data storage element for storing customer data, including customer premises location information. A technician uses a mobile communication device to automatically detect the product identifier. The mobile communication device has a location sensor configured to determine the location of the device, such as, for example, global positioning system (GPS) coordinates. The mobile communication device is configured to wirelessly transmit a message indicative of the product identifier and the location of the device to the data storage element via a cellular network or otherwise, and the data storage element is configured to automatically associate the product identifier with a customer based on the customer data and the location of the device.

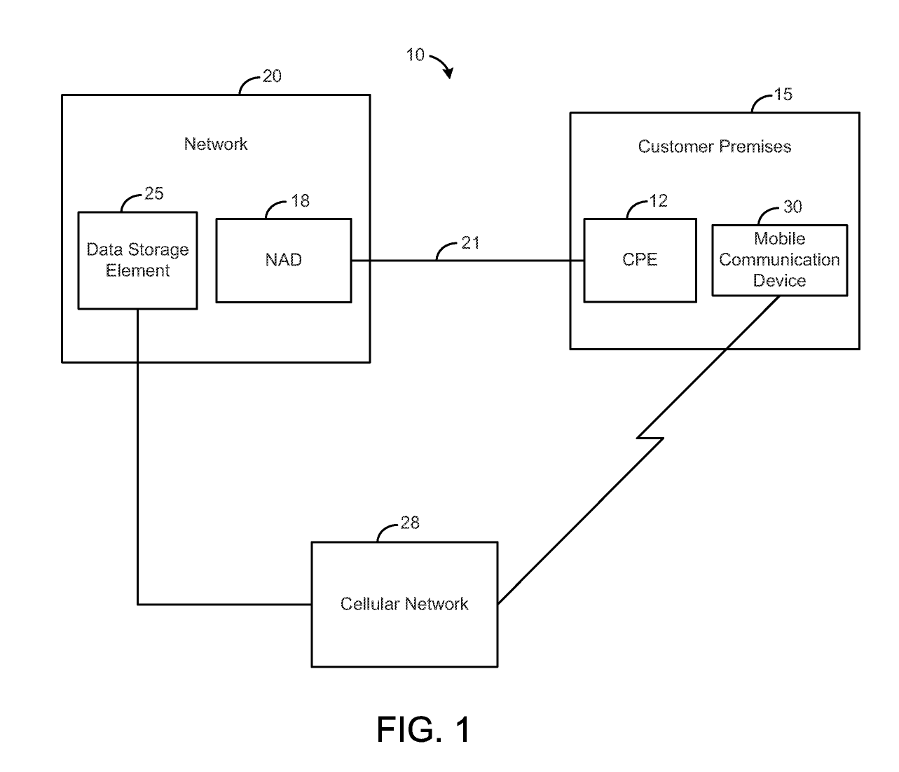

FIG. 1 depicts an exemplary communication system 10. In one embodiment, the communication system 10 comprises CPE 12, such as, for example, a modem, a set-top box, or equipment for powering other equipment, installed at a customer premises 15. The CPE 12 has a product identifier (not shown in FIG. 1), such as a serial number or barcode, located on a housing (not shown in FIG. 1) of the CPE 12, as will be described in more detail hereafter, though the identifier may be located elsewhere, if desired. In one embodiment, the product identifier is used to associate the CPE 12 with a customer based on the location of the customer premises 15 where the CPE 12 is installed, as will be discussed in more detail hereafter.

The CPE 12 is coupled to a network access device (NAD) 18 of a network 20 via a subscriber line 21. The CPE 12 is configured to transmit data signals to the NAD 18 via the subscriber line 21 and to receive signals from the NAD 18 via the subscriber line 21. The NAD 18, such as, for example, a switch or a digital subscriber line access multiplexer (DSLAM), may be located at a central office or at some intermediate point between the central office and the customer premises 15.

The communication system 10 further comprises a mobile communication device 30, such as, for example, a cellular telephone, personal digital assistant (PDA), or a lap-top computer, positioned at the customer premises 15. The device 30 is configured to detect the product identifier of the CPE 12. In one embodiment, the device 30 detects the product identifier utilizing an optical detection module (not shown in FIG. 1), discussed in more detail hereafter, but other types of devices may be used to determine the product identifier. When installing the CPE 12, a technician carries the mobile communication device 30 to the customer premises 15, and the device 30 is configured to determine location data indicative of the location of the device 30, such as, for example, the GPS coordinates of the device 30, using a location sensor (not shown in FIG. 1) while the technician is at the customer premises 15 for installation of the CPE 12.

The device 30 is configured to wirelessly transmit a message, such as an email message or a text message, indicative of the product identifier and the location of the device 30 to a data storage element 25 located in the network 20 through a cellular network 28. For example, in one exemplary embodiment, the device 30 may be configured to use optical character recognition (OCR) techniques in order to determine the product identifier, such as the serial number. Once the product identifier is determined, the device 30 transmits the product identifier and the location data (e.g., GPS coordinates) to the data storage element 25 via a message through the cellular network 28. However, in another embodiment, discussed in more detail hereafter, the device 30 may transmit an image of the product identifier, along with the location data, to the data storage element 25 in order to allow the data storage element to extract the product identifier from the image. Other methods and techniques for transmitting the message indicative of the product identifier will be discussed hereafter.

In one embodiment, the data storage element 25 is configured to store customer data (e.g. name, address, customer promises location information, and the product identifiers of equipment located at the premises of the customer) for a plurality of customers. The data storage element 25 is also configured to receive the message indicative of the product identifier and the location from the mobile communication device 30. In one exemplary embodiment, the data storage element 25 may receive a message containing the product identifier and the location data. However, in another embodiment, described in more detail hereafter, the data storage element 25 may receive a message containing an image of the product identifier. In such embodiment, the data storage element 25 is configured to use OCR techniques to analyze the image and determine the product identifier. Other methods of determining the product identifier are possible in other embodiments.

The data storage element 25 is further configured to automatically associate the product identifier with a customer based on the location data received from the device 30 and customer premises location information stored in the customer data. In this regard, the data storage element 25 compares the location data received from the device 30 with the customer premises location information stored in the customer data. Upon identifying the customer premises 15 corresponding to the location data, the data storage element 25 associates the product identifier 38 in the data storage element 25 with the customer of the identified premises. Accordingly, the CPE 12 is automatically registered.

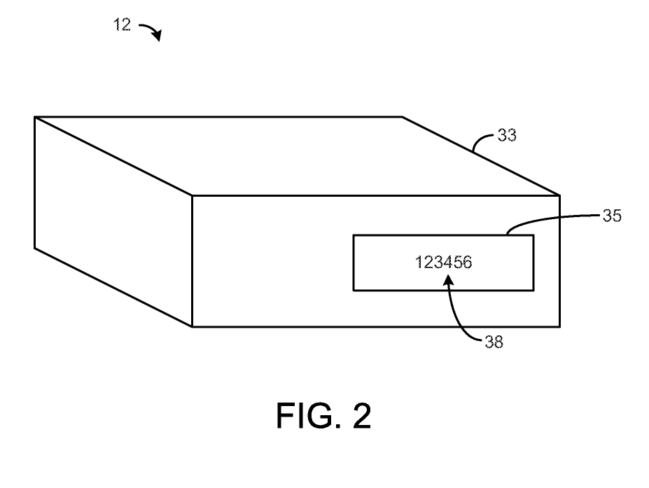

FIG. 2 depicts an exemplary embodiment of the CPE 12 of FIG. 1. As set forth above, in one embodiment, the CPE 12 may implement a modem, a set-top box, equipment for powering other equipment, or other telecommunication equipment installed at a customer premises. As shown by FIG. 2, the CPE 12 has a housing 33 for protecting components of the CPE 12. A label 35 is positioned on an outer surface of the housing 33, and the label 35 displays a product identifier 38 of the CPE 12. For example, as set forth in FIG. 2, the product identifier 38 is a serial number, although other types of product identifiers are possible in other embodiments.

Upon installation of the CPE 12 at the customer premises 15 (FIG. 1) or at some other time period, the technician or other person may use the mobile communication device 30 (FIG. 1) to detect the product identifier 38. Once the product identifier 38 is detected, the device 30 wirelessly transmits a message indicative of the product identifier 38 and the location of the device 30 to the data storage element 25 (FIG. 1). Note that such location is sensed while the mobile communication device 30 is at the customer premises 15.

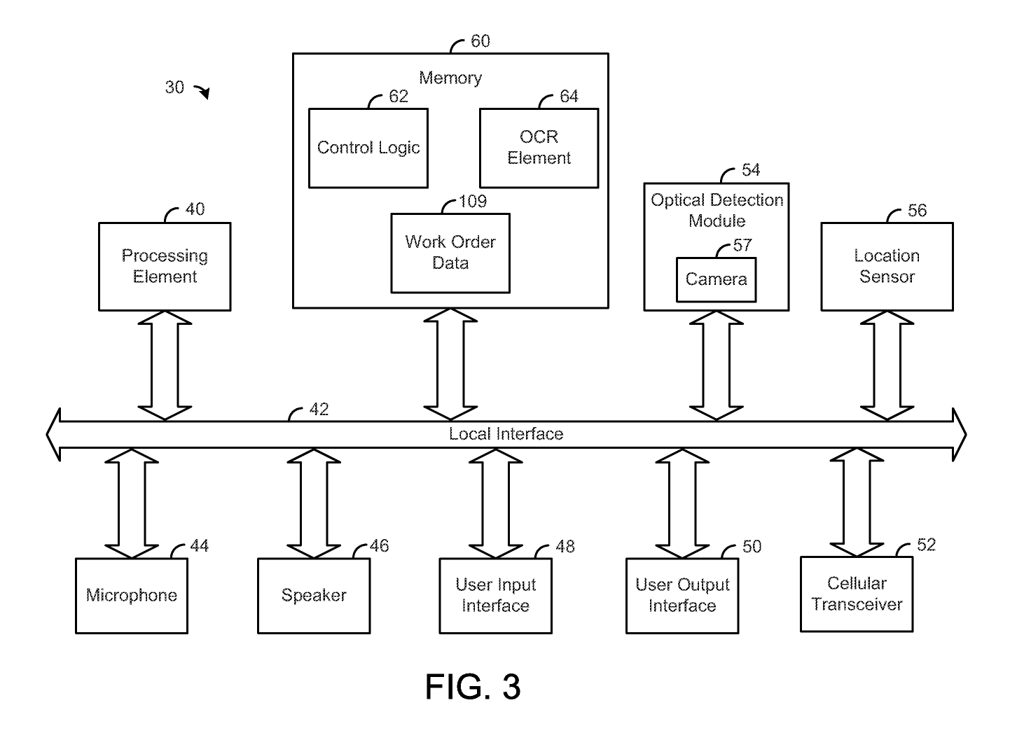

FIG. 3 depicts an exemplary embodiment of the mobile communication device 30 of FIG. 1. As set forth above, the mobile communication device 30 is used by a technician at the customer premises 15 (FIG. 1) during installation of the CPE 12 (FIG. 1). The mobile communication device 30 comprises at least one conventional processing element 40, such as a central processing unit (CPU) or digital signal processor (DSP), that communicates to and drives the other elements within the device 30 via a local interface 42. The device 30 also comprises a microphone 44 for receiving acoustic sound into the device 30 and a speaker 46 for transmitting acoustic sound from the device 30. Furthermore, the device 30 comprises a user input interface 48, such as, for example, a keypad or touchpad, which can be used to manually input data into the device 30. The device 30 also comprises a user output interface 50, for example, a screen, which can be used to display data.

The mobile communication device 30 further comprises a cellular transceiver 52, which is configured to wirelessly communicate with the cellular network 28 (FIG. 1). In one embodiment, the cellular transceiver 52 transmits messages indicative of the product identifier 38 (FIG. 2) and the device location to the data storage element 25 via the cellular network 28. Furthermore, the device 30 comprises an optical detection module 54 configured to optically detect the product identifier 38 of the CPE 12. In one exemplary embodiment, the optical detection module 54 comprises a camera 57 that can be used to capture an image of the product identifier 38, although other types of modules 54 and techniques for capturing the product identifier 38 are possible in other embodiments. As an example, the optical detection module 54 may comprise a scanner that can be used to scan the product identifier 38. U.S. Pat. No. 7,634,448, entitled “Self-Service Checkout During Item Purchase via Videophone,” which is incorporated herein by reference, and U.S. Pat. No. 7,006,665, entitled “Adaptive, Product Control and Stabilization Sub-System for Camera-Based Optical Character Recognition, and a Method of Operating the Same,” which is incorporated herein by reference, describe exemplary techniques for optically detecting a product identifier.

The device 30 further comprises a location sensor 56, such as a GPS sensor, for automatically determining the location of the device 30. In one embodiment, the location sensor 56 detects the precise GPS coordinates of the device 30 to enable association of the product identifier 38 with a particular customer based on customer data (not shown in FIG. 3), discussed in more detail hereafter. However, other types of location sensors 56 for determining the location of the device 30 are possible in other embodiments.

The device 30 further comprises control logic 62 configured to control the operation of the device 30 as described herein. It should be noted that the control logic 62 can be implemented in software, hardware, firmware or any combination thereof. In the exemplary embodiment illustrated in FIG. 3, the control logic 62 is implemented in software and stored in memory 60 of the device 30. In one embodiment in which the optical detection module 54 comprises a camera 57, an OCR element 64 is also implemented in software and stored in the memory 60 of the device 30, although the OCR element 64 may be implemented in hardware, firmware, software, or any combination thereof in other embodiments. The OCR element 64 is configured to analyze the image of the product identifier 38 captured by the camera 57 and to determine the product identifier 38 using conventional OCR techniques. The control logic 62 is further configured to instruct the cellular transceiver 52 to transmit a message indicative of the product identifier 38 and the location of the device 30 to the data storage element 25 once the OCR element 64 determines the product identifier 38. In an alternative embodiment, discussed in more detail hereafter, the OCR element 64 may be located in the data storage element 25 such that the product identifier 38 is determined after the message is transmitted to the element 25.

Note that the control logic 62 and/or OCR element 64, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

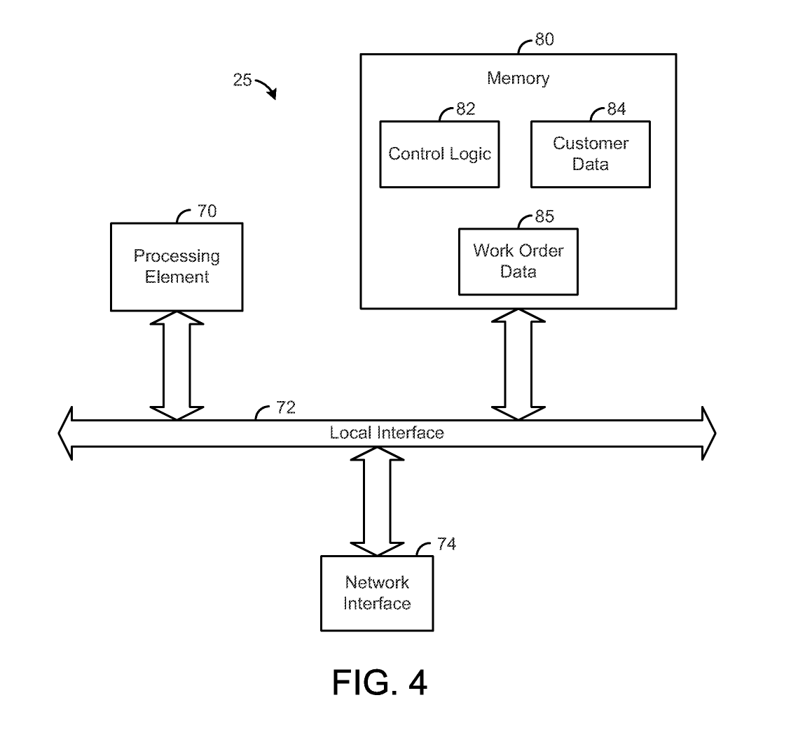

FIG. 4 depicts an exemplary embodiment of the data storage element 25 of FIG. 1. As set forth above, the data storage element 25 is within the network 20, although other locations of the data storage element 25 are possible, and the data storage element 25 is configured to store data and to communicate with the mobile communication device 30. In one embodiment, the data storage element 25 comprises at least one conventional processing element 70, such as a CPU or DSP, that communicates to and drives the other elements within the data storage element 25 via a local interface 72. The data storage element 25 further comprises a network interface 74 for enabling communication with the cellular network 28 (FIG. 1) and/or other components of the network 20. In one embodiment, the network interface 74 receives at least one message indicative of the product identifier 38 (FIG. 2) and the location of the device 30 via the cellular network 28.

The data storage element 25 further comprises control logic 82 configured to control the data entry process for the data storage element 25. The control logic 82 manages customer data 84 and work order data 85 stored in memory 80 of the data storage element 25. The control logic 82 can be implemented in software, hardware, firmware or any combination thereof. In the exemplary embodiment illustrated in FIG. 4, control logic 82 is implemented in software and stored in the memory 80 of the data storage element 25. When implemented in software, the control logic 82 can be stored and transported on any computer-readable medium for use by or in connection with an instruction execution apparatus that can fetch and execute instructions.

The customer data 84 indicates various information about customers of the network service provider, such as, for example, customer name, address, location information, and the product identifier 38 of the CPE 12 (FIG. 1). The work order data 85 indicates various information about work orders for technicians of the network service provider. As an example, for each work order, the data 85 may indicate a work order identifier, a description of the work to be performed by the technician, and a customer identifier identifying the customer to which the work order pertains. Such customer identifier may be used to correlate the work order with the customer information in the customer data 84 pertaining to the identified customer, as will be described in more detail hereafter.

The control logic 82 is further configured to analyze messages received from the device 30 via the cellular network 28. In one embodiment, the device 30 transmits a message (e.g., a text message or email message) containing the product identifier 38 and the location of the device 30, such as the GPS coordinates, to the data storage element 25, as set forth above. However, other types of messages, such as messages containing image data, are possible in other embodiments. The control logic 82 is configured to retrieve the location of the device 30 from the message and to search the customer data 84 for customer premises location information that corresponds with the location of the device 30 in order to identify the appropriate customer to be associated with the product identifier 38.

Upon identifying the appropriate customer based on the location of the device 30 and the customer data 84, the control logic 82 is configured to automatically associate the product identifier 38 with the identified customer in the customer data 84. In one exemplary embodiment, depicted by FIG. 4, the control logic 82 performs the association by retrieving the product identifier 38 from the message and storing the product identifier 38 in an entry in the customer data 84 corresponding to the identified customer. However, in other embodiments, other techniques of automatically associating the product identifier 38 with the appropriate customer are possible. For example, in an alternative embodiment, discussed in more detail hereafter, the message may contain an image of the product identifier 38 and the data storage element 25 may comprise an OCR element (not shown) stored in the memory 80 for analyzing the image of the product identifier 38. In such embodiment, the control logic 82 instructs the OCR element to determine the product identifier 38 from the image in order to allow the control logic 82 to automatically associate the product identifier 38 with the appropriate customer in the customer data 84. Accordingly, the data storage element 25 automatically registers the CPE 12 based on the message received from the mobile communication device 30.

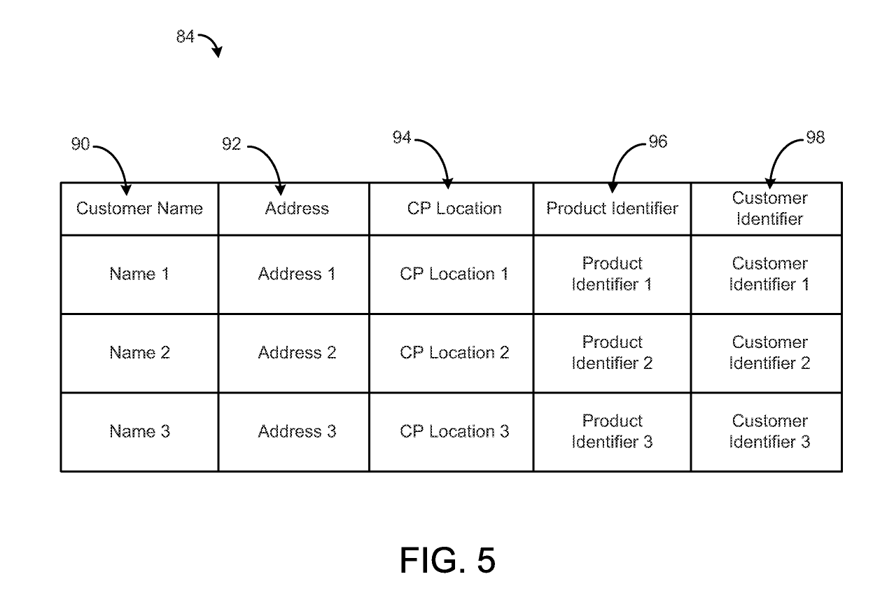

FIG. 5 depicts an exemplary embodiment of the customer data 84 of FIG. 4. The customer data 84 defines a plurality of entries in which each entry stores information about a respective customer. As shown by FIG. 5, each entry of the customer data 84 has a plurality of fields, such as a customer name field 90, an address field 92, a CP location field 94, a product identifier field 96, and a customer identifier field 98. The customer name field 90 indicates the name of the customer associated with the entry. The address field 92 indicates an address (e.g., street address) of the customer associated with the entry.

The CP location field 94 indicates the location of the customer premises to which equipment is to be installed in order to provide services to the customer associated with the entry. As an example, the CP location field 94 may include a plurality of location coordinates, such as GPS coordinates, defining a boundary of the location at which equipment is to be installed. As an example, for a residential customer in a residential subdivision, the CP location field 94 might define the boundary of the customer's lot within the residential subdivision. Moreover, when equipment for servicing the customer is installed, such equipment should reside within the boundary defined by the CP location field 94.

The product identifier field 96 includes the product identifiers of CPE 12 installed at the location indicated by the CP location field 94. Thus, the product identifier field 96 can be analyzed to determine which CPE 12 is currently installed for the customer associated with the entry.

The customer identifier field 98 includes a customer identifier that uniquely identifies the customer associated with the entry from all other customers of the network service provider. In one exemplary embodiment, the customer identifier is a string of alphanumeric characters that are unique to the customer. Other types of customer identifiers are possible in other embodiments.

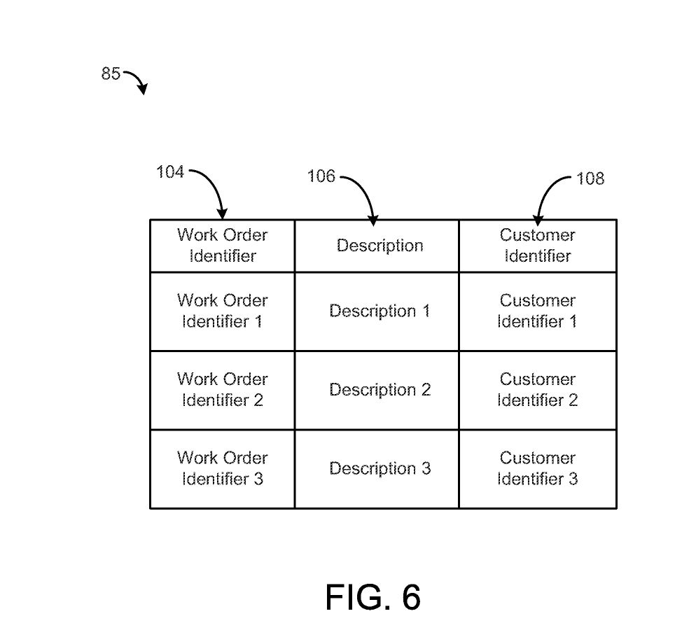

FIG. 6 depicts an exemplary embodiment of the work order data 85 of FIG. 4. The work order data 85 defines a plurality of entries in which each entry stores information about a respective work order. As shown by FIG. 6, each entry of the work order data 85 has a plurality of fields, such as a work order identifier field 104, a description field 106, and a customer identifier field 108.

The work order identifier field 90 includes a work identifier that uniquely identifiers the work order associated with the entry from all other work orders of the network service provider. In one exemplary embodiment, the work order identifier is a string of alphanumeric characters that are unique to the work order. Other types of work order identifiers are possible in other embodiments.

The description field 106 indicates a description of the work that is to be performed for the work order. As an example, the description field 106 may indicate the type of service to be provided to the customer, the type of repair to be performed by the technician, the type of problem experienced by the customer, and/or the type of equipment to be installed by the technician. Various other descriptions are possible in other embodiments depending on the type of work to be performed for the work order.

The customer identifier field 108 includes the customer identifier of the customer for which the work order pertains. Note that, for the same customer, the same customer identifier may be used in both the customer data 84 and the work order data 85 thereby providing a correlation between the customer and the work order. For example, using the customer identifier in the field 108 of the work order data 85, the customer information, such as name, address, and location information, may be found in the customer data 84. Similarly, using the customer identifier in the field 98 of the customer data 84, the work order information pertaining to the identified customer can be found in the work order data 85.

For illustrative purposes assume that, for a particular work order, a technician is to install the CPE 12 of FIG. 2 at a premises of a customer. In one exemplary embodiment, the technician uses the mobile communication device 30 to assist in completing the work order, as will be described in more detail below.

In this regard, prior to performing the work order, the technician uses the device 30 to communicate with the data storage element 25. As an example, the technician may make a cellular call through the cellular network 28 to the data storage element 25. Alternatively, if the technician is at the premises of the data storage element 25, the technician may physically connect the device 30 to the data storage element 25. Other techniques for establishing communication between the device 30 and the data storage element are possible in other embodiments.

During the communication, the information in the entries of the data 85 for work orders to be completed by the technician are downloaded to the mobile communication device 30 and stored in memory as work order data 109, as shown by FIG. 3. Thus, the work order data 109 may include a subset of the entries of the work order data 85 stored by the data storage element 25.

For each work order entry downloaded to the device 30, the control logic 82 of the data storage element 25 is configured to retrieve customer information from the data 84 correlated with the work order and download such customer information as well. For example, for a work order entry downloaded to the device 30, the control logic 82 is configured to use the customer identifier in the field 108 as a key to find the entry in the customer data 84 pertaining to the identified customer. From such entry, the control logic 82 retrieves the information from fields 90, 92, and 94 and downloads such retrieved information to the device 30. Thus, the work order data 109 can be analyzed to determine not just the work to be performed for a given work order but also the name, address, and location of the customer for which the work is to be performed. In one exemplary embodiment, the work order data 109, similar to the work order data 85 described above, has a plurality of entries with each entry being associated with a respective work order and indicating information about the work order. However, each entry includes not only the work order description but also the customer information from the data 85, such as customer name, customer address, and CP location, correlated with the same customer.

After arriving at the customer premises 15 for performing a given work order, the technician accesses the relevant work order information from the data 109. As an example, the technician may provide inputs via the user input interface 48 (FIG. 3) for displaying the work order data 109 and selecting the entry pertaining to the customer's work order. In response to such selecting, the control logic 62 may display information from the selected entry, such as the description of the work to be performed.

In one exemplary embodiment, the selection of the work order entry and, hence, selection of the information in the work order entry is based on the CP location information. In this regard, as described above, the work order entry includes the CP location information from the CP location field 94 (FIG. 5) indicative of the geographic location of the premises of the identified customer. For illustrative purposes, assume hereafter that such CP location information includes location coordinates defining a boundary of the customer premises 15. The control logic 62 of the mobile communication device 30 is configured to automatically compare such CP location information of the selected work order entry to the location indicated by the location sensor 56 when the work order entry is selected by the technician in an effort to confirm that the technician has not made a work order selection error.

In particular, the control logic 62 compares the location data from the location sensor 56 with the CP location information to determine whether the location, as indicated by the location sensor 56, is within the boundary defined by the CP location information. If so, the control logic 62 determines that the correct work order entry has been selected. However, if the location indicated by the location sensor 56 is outside of the boundary defined by the CP location information of the selected work order entry, then the control logic 62 determines that a selection error may have occurred. In response, the control logic 62 is configured to display or otherwise render a warning message to the technician via the user output interface 50. As an example, the warning message may indicate that the selected work order does not correspond to the current location of the device 30. Thus, the technician is warned of the potentially erroneous selection and, in response, may select another work order entry if he or she believes that an incorrect entry has, in fact, been selected.

In one exemplary embodiment, the selection of the work order entry is automatically performed by the control logic 62. For example, upon arriving at the customer premises 15, the control logic 62 may be configured to search the work order data 109 for an entry corresponding to the location of the device 30, as indicated by the location sensor 56. Such search may be triggered by a user input. As an example, upon arriving at the customer premises 15, the technician may provide an input that causes the control logic 62 to search for the corresponding entry without manually specifying which entry is to be selected. Thereafter, the control logic 62 automatically selects the entry corresponding to the location indicated by the location sensor 56. That is, in the instant example, the control logic 62 selects the work order entry having CP location data defining a boundary in which the device 30 is located, as indicated by the location sensor 56.

In another example, rather than have the technician provide an input indicating when he or she arrives at the customer premises 15, the control logic 62 may be configured to periodically poll the location sensor 56 to automatically determine when the technician has arrived at a location corresponding to a work order entry. In response to such determination, the control logic 62 may automatically select and display the corresponding work order entry. Whether selected manually or automatically, the selected entry shall be referred to hereafter as the “current work order.”

While at the customer premises 15, such as just prior to installing the CPE 12 or after installing the CPE 12, the technician uses the mobile communication device 30 to correlate the product identifier 38 of the CPE 12 with the current work order and, specifically, with the customer identified by the current work order. For example, the technician may manually enter the product identifier 38 via the user input interface 48. However, in one exemplary embodiment, the technician uses the optical detection module 54 to automatically detect the product identifier thereby preventing possible manual entry mistakes. For example, the product identifier 38 may be implemented as a barcode, and the module 54 may be configured to optically scan the barcode to determine the product identifier 38. In another example, the optical detection module 54 comprises a camera 57, which captures an image of the label 35 and, hence, the product identifier 38. In such example, the OCR element 64 may be used to analyze the image data in order to determine the product identifier 38.

Regardless of the techniques used to acquire data indicative of the product identifier 38, the control logic 62 is configured to transmit such data to the data storage element 25 for registering the CPE 12 with the customer. In one exemplary embodiment, the control logic 62 forms a message such as a text message or email message and includes in the message the data indicative of the product identifier 38. Such data may be image data captured by the camera 57 or textual data defining the characters of the product identifier 38 as determined from manual entry, scanning of the label 35, OCR analysis of an image from the camera 57, or otherwise. Yet other forms of the data are possible in other embodiments.

The control logic 62 also inserts into the message other information that is useful for registering the CPE 12. As an example, the control logic 62 may insert the customer identifier indicated by the current work order entry, if such information is available to the device 30. Such information may be used to by the data storage element 25 to correlate the product identifier 38 with the appropriate customer. However, in some instances, the customer identifier may not be available to the device 30. As an example, the work order data 109 may not be downloaded into the device 30. In such case, other information is used to correlate the product identifier 38 with the appropriate customer in the customer data 84.

In one exemplary embodiment, location information is used for such correlation. In this regard, when the data indicative of the product identifier 38 is acquired by the device 30, the control logic 62 is configured to determine location data indicative of the device's location, which is at the premises where the CPE 12 is being installed. The control logic 62 inserts such location data into the message being transmitted to the data storage element 25, and the message is transmitted through the cellular network 28 or otherwise to the data storage element 25.

When the message is received at the data storage element 25, the control logic 82 compares the location data in such message to the CP location information in the entries of the customer data 84 to find the entry corresponding to the location data. In one exemplary embodiment, an entry is deemed to be corresponding when the location indicated by the location data is within the boundary indicated by the entry's CP location field 94. When such entry is identified, the control logic 82 is configured to store data defining the product identifier 38 of the message in the product identifier field 96. Preferably, the text of the product identifier 38 is stored in the field 96. If the message includes image data captured by the camera 57, the control logic 82 may convert the image data to text via OCR and store the text of the product identifier 38 in the field 96. As an example, the OCR element 64 of FIG. 3 may reside at the data storage element 25 rather than at the mobile communication 30. In addition or as an alternative to storing the text of the product identifier 38, the image data may be stored in or otherwise correlated with the customer's entry in the data 84, if desired. Such image data may be used to view and/or determine the product identifier 38. If an OCR mistake results in an erroneous product identifier 38, the image data may be useful to resolve the problem.

Accordingly, the process of acquiring the product identifier 38 and associating the product identifier 38 with the appropriate customer in the customer data 84 is facilitated. Further, by removing some of the manual steps typically performed by the technician, at least some mistakes can be prevented resulting in a more reliable registration process.

In one exemplary embodiment, the system 10 may be configured as set forth above with respect to FIGS. 1-5. When the cellular transceiver 52 of the device 30 transmits the message indicative of the product identifier 38 to the data storage element 25, the control logic 82 searches the customer data 84 in order to locate an entry corresponding to the location of the device 30. If desired, the control logic 82 may be configured to transmit a message indicative of successful CPE registration to the device 30 via the cellular network 28 upon finding a corresponding entry in the customer data 84. Such message is displayed to the technician via the user output interface 50. Furthermore, the control logic 82 may also be configured to transmit a warning message indicative of a failed CPE registration to the device 30 via the cellular network 28 if the control logic 82 fails to find a corresponding entry. Such warning message may also be displayed to the technician via the user output interface 50. In response to such message, the technician may troubleshoot and confirm that the product identifier 38 is properly registered while the technician is still on site at the customer premises 15.

In one exemplary embodiment, assume that the optical detection module 54 comprises a camera 57 and the location sensor 56 comprises a GPS sensor. Also assume that the OCR element 64 is stored in the memory 60 of the device 30. Furthermore, assume that the product identifier 38 comprises a serial number located on the label 35 of the housing 33 of the CPE 12.

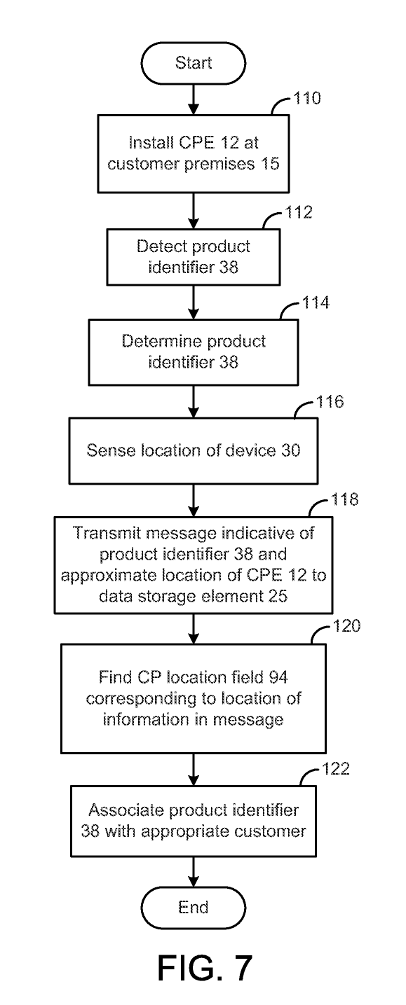

When the technician installs the CPE 12 at the customer premises 15, as shown by block 110 of FIG. 7, the technician manipulates the camera 57 such that it detects the product identifier 38 by capturing an image of the product identifier 38, as shown by block 112. The control logic 62 then instructs the OCR element 64 to analyze the image in order to determine the text of the product identifier 38, as shown by block 114. In such embodiment, the OCR element 64 uses OCR techniques to determine the actual serial number from the image. The location sensor 56 also senses the location of the device 30, as shown by block 116, thereby providing a set of location data indicating the approximate location of the installed CPE 12. The cellular transceiver 52 then wirelessly transmits via the cellular network 28 a message indicative of the product identifier 38 and the location data to the data storage element 25, as shown by block 118.

Upon receiving the message, the control logic 82 of the data storage element 25 retrieves the location information from the message and searches the customer data 84 for a corresponding CP location field 94 in order to locate the appropriate customer, as shown by block 120. Upon finding the corresponding CP location field 94, the control logic 82 of the data storage element 25 stores the product identifier 38 from the message in the same entry as the corresponding CP location field 94 thereby associating the product identifier 122 with the customer identifier in the same entry and, hence, the customer identified by the entry, as shown by block 122.

1. (canceled)

2. The system of claim 5, wherein the data storage element is configured to store customer premises (CP) location data indicative of a location for a customer identified by the customer identifier, and wherein the data storage element is configured to associate the product identifier with the customer identifier based on a comparison of the CP location data to the location data received from the mobile communication device.

3. The system of claim 2, wherein the CP location data defines a boundary at the customer premises.

4. The system of claim 3, wherein the location data includes coordinates indicative of the location of the mobile communication device, wherein the data storage element is configured to compare the coordinates to coordinates in the CP location data defining the boundary in order to determine whether the location of the mobile communication device is within the boundary, and wherein the data storage element is configured to associate the product identifier with the customer identifier in response to a determination that the location of the mobile communication device is within the boundary.

5. A telecommunication system, comprising:
a mobile communication device configured to store product identifier data indicative of a product identifier for customer premises equipment (CPE) installed at a customer premises and coupled to a network by a subscriber line for communicating with the network, wherein the product identifier is located on the CPE and the CPE is configured to communicate data signals with a network access device of the network across the subscriber line, the mobile communication device having a location sensor and configured to determine, based on the location sensor, location data indicative of a location of the mobile communication device, wherein the mobile communication device has an optical detection module configured to optically detect the product identifier; and
a data storage element configured to receive the product identifier data and the location data from the mobile communication device, the data storage element having memory for storing customer data, wherein the data storage element is configured to automatically associate in the customer data the product identifier indicated by the product identifier data with a customer identifier based on the location data.

6. The system of claim 5, wherein the optical detection module comprises a camera for capturing an image of the product identifier, and wherein the product identifier data is based on the image.

7. The system of claim 6, wherein one of the mobile communication device and the data storage element is configured to determine the product identifier from the image using optical character recognition.

8. A telecommunication system, comprising:
customer premises equipment (CPE) installed at a customer premises and coupled to a network for communicating with the network, the CPE associated with a product identifier that is located on the CPE and identifies the CPE;
a data storage element configured to store customer data mapping product identifiers to customer identifiers; and
a mobile communication device configured to determine a location of the device and to transmit the product identifier and location data indicative of the location to the data storage element, wherein the mobile communication device has an optical detection module configured to optically detect the product identifier, and wherein the data storage element is configured to automatically associate the product identifier with a customer identifier based on the location data.

9. The system of claim 8, wherein the data storage element is configured to store customer premises (CP) location data indicative of a location for a customer identified by the customer identifier, and wherein the data storage element is configured to associate the product identifier with the customer identifier based on a comparison of the CP location data to the location data received from the mobile communication device.

10. The system of claim 9, wherein the CP location data defines a boundary at the customer premises.

11. The system of claim 10, wherein the data storage element is configured to associate the product identifier with the customer identifier in response to a determination that the location data from the mobile communication device indicates a location within the boundary.

12. The system of claim 8, wherein the optical detection module comprises a camera and an optical character recognition element (OCR) element, wherein the OCR element is configured to determine the product identifier based on image data from the camera.

13. (canceled)

14. The method of claim 19, wherein the optically detecting step comprises the step of capturing an image of the product identifier, and wherein the product identifier data defines the image.

15. The method of claim 19, wherein the optically detecting step comprises the step of capturing an image of the product identifier, the method further comprising the step of analyzing the image via optical character recognition, wherein the product identifier data is based on the analyzing step.

16. The method of claim 19, further comprising the steps of:
storing customer premises (CP) location data indicative of a location for the customer; and
comparing the CP location data and the location data wirelessly transmitted from the mobile communication device,
wherein the associating step is based on the comparing step.

17. The method of claim 16, wherein the CP location data defines a boundary at the premises.

18. The method of claim 17, further comprising the step of determining whether the location indicated by the location data wirelessly transmitted from the mobile communication device is within the boundary, wherein the associating step is based on the determining whether step.

19. A method, comprising the steps of:
installing telecommunication equipment at a premises of a customer;
causing the telecommunication equipment to transmit data signals across a subscriber line coupled to the telecommunication equipment;
optically detecting a product identifier on the telecommunication equipment with an optical detection module of a mobile communication device, the product identifier identifying the telecommunication equipment;
automatically determining, by the mobile communication device, location data indicative of a location of the mobile communication device based on a location sensor of the mobile communication device;
wirelessly transmitting, by the mobile communication device, the location data and product identifier data from the mobile communication device, the product identifier data indicative of the product identifier;
receiving, at a data storage element, the wirelessly transmitted location data and product identifier data;
storing customer data in memory; and
automatically associating the product identifier with a customer identifier in the customer data based on the received location data, the customer identifier identifying the customer.

20. The method of claim 19, wherein the mobile communication device is a cellular telephone, and wherein the wirelessly transmitting step comprises the step of wirelessly transmitting the location data and the product identifier data from the mobile communication device via a cellular connection.

21. The method of claim 19, further comprising the steps of storing work order data in the mobile communication device and selecting stored work order data, by the mobile communication device, based on location data indicative of a location of the mobile communication device, wherein the work order data is indicative of a work order for installing the telecommunication equipment.

22. The system of claim 5, wherein the mobile communication device is a cellular telephone, and wherein the mobile communication device is configured to transmit the product identifier data and the location data to the data storage element via a cellular connection.

23. (canceled)

24. The system of claim 5, wherein the mobile communication device is configured to store a plurality of work order entries, each of the plurality of work order entries indicative of a respective work order to be completed by a user of the mobile communication device, wherein the mobile communication device is configured to select one of the work order entries based on the location sensor, wherein the selected work order entry is indicative of a work order for installing the CPE, and wherein the mobile communication device is configured to display information from the selected work order entry, including a type of CPE to be installed at the customer premises, in response to selection of the work order entry based on the location sensor.

25. The system of claim 24, wherein the selected work order entry includes the customer identifier, and wherein the mobile communication device is configured to transmit the customer identifier, the product identifier data, and the location data to the data storage element.

26. The method of claim 19, further comprising the steps of:
storing work order entries in the mobile communication device, each of the plurality of work order entries indicative of a respective work order to be performed by a user of the mobile communication device;
selecting one of the work order entries for the customer;
displaying, via the mobile communication device, information from the selected work order entry in response to the selection of the work order entry, the information from the selected work order entry including a type of telecommunication equipment to be installed at the premises of the customer;
after the user arrives at the premises of the customer, determining second location data indicative of a location of the mobile communication device with the location sensor;
comparing the second location data to location information relating to the premises of the customer in the selected work order entry;
determining whether the selecting is erroneous based on the comparing step; and
displaying a warning via the mobile communication device if the selecting is determined to be erroneous.

27. The method of claim 26, wherein the selected work entry includes the customer identifier, and wherein the wirelessly transmitting step comprises the step of wirelessly transmitting the location data, the product identifier data, and the customer identifier from the mobile communication device.

28. The method of claim 19, wherein the determining step and the transmitting step are performed in response to the detecting step.

29. The system of claim 5, wherein the mobile communication device is configured to automatically determine the location data in response to the detection of the product identifier and to insert the location data into a message with the product identifier, the mobile communication device configured to wirelessly transmit the message to the data storage element in response to the detection of the product identifier.

30. The system of claim 8, wherein the mobile communication device has a location sensor, wherein the mobile communication device is configured to automatically determine the location of the device based on the location sensor and to automatically transmit a message to the storage element in response to the detection of the product identifier, and wherein the message includes the product identifier and the location data.
